(19) United States
(12) Patent Application Publication
(10) Pub. No.: US 2009/0146394 A1
(43) Pub. Date: Jun. 11, 2009

(54) WAGON

(76) Inventors: Paul Tyson Seivert, Phoenix, AZ (US); Gena Elizabeth Seivert, Phoenix, AZ (US)

Correspondence Address: DAVIS WRIGHT TREMAINE, LLP/Seattle, 1201 Third Avenue, Suite 2200, SEATTLE, WA, 98101-3045, US

(21) Appl. No.: 11/952,359

(22) Filed: Dec. 7, 2007

(51) Int. Cl. B60D 1/24

(52) U.S. Cl. 280/504

(57) ABSTRACT

An assembly for removably coupling a cart to a towing hitch of a vehicle. The assembly includes a support member having a first end portion configured to be coupled to the towing hitch and a second end portion configured to be coupled to an underside of the cart. The second end portion is offset vertically relative to the first to support the cart above the towing hitch. The assembly includes one or more brackets coupled to the underside of the cart and arranged to be coupled to the second end portion. The support member includes a through-hole for each bracket and the through-holes in the support member are aligned with corresponding through-holes formed in the brackets. Fasteners are inserted into the aligned through-holes to maintain engagement between the support member and the brackets.

### BACKGROUND OF THE INVENTION

1. Field of the Invention

The present invention is directed generally to mounting assemblies configured to mount a cart to a vehicle for transport.

2. Description of the Related Art

Carts such as wagons, wheelbarrows, two-wheel carts, and the like are convenient devices for manually hauling cargo. However, carts tend to be somewhat large, occupying a relatively large footprint, and generally do not fold or otherwise collapse to save space. Therefore, one typically needs a truck having a bed, a trailer, a passenger vehicle with a large cargo space or trunk, or the like to transport a cart. However, if one is transporting other cargo, such as equipment and materials, the space taken up by the cart can be problematic.

Some cargo can be loaded into the cart during transport but if the cart must be lifted to a significant height (e.g., into the bed of a truck or to the roof of a vehicle for mounting thereto), one may have to unload the cart before lifting it. After the cart is stowed, the cargo may be reloaded into the cart for transport. Unfortunately, loading and unloading the cart in this manner wastes time and energy.

Further, the wheels and other supports of the cart are disposed on the ground and therefore are often covered in dirt. Even if one has space inside a passenger vehicle for the cart, it is often undesirable to transport the cart inside the vehicle because the dirt on the wheels and other supports will be introduced into the vehicle.

Therefore, a need exists for a mounting assembly configured to mount a cart to the outside of a vehicle for transport. A further need exists for a method of transporting a cart that does not require unloading the cart before transport. The present application provides this and other advantages as will be apparent from the following detailed description and accompanying figures.

### BRIEF DESCRIPTION OF THE SEVERAL VIEWS OF THE DRAWING(S)

FIG. 1 is a perspective view of an embodiment of a cart coupled to a mounting assembly.

FIG. 2 is a side perspective view of the mounting assembly of FIG. 1 coupling the cart to a towing hitch receiver of an exemplary vehicle for transport.

FIG. 3 is a bottom perspective view of an underside of the cart coupled to the mounting assembly of FIG. 1.

FIG. 4 is a side perspective view of a support member uncoupled from both the cart and the towing hitch receiver of the vehicle of FIG. 2.

FIG. 5 is a bottom perspective view of an underside of a frame assembly of the mounting assembly of FIG. 3 show disconnected from the cart.

### DETAILED DESCRIPTION OF THE INVENTION

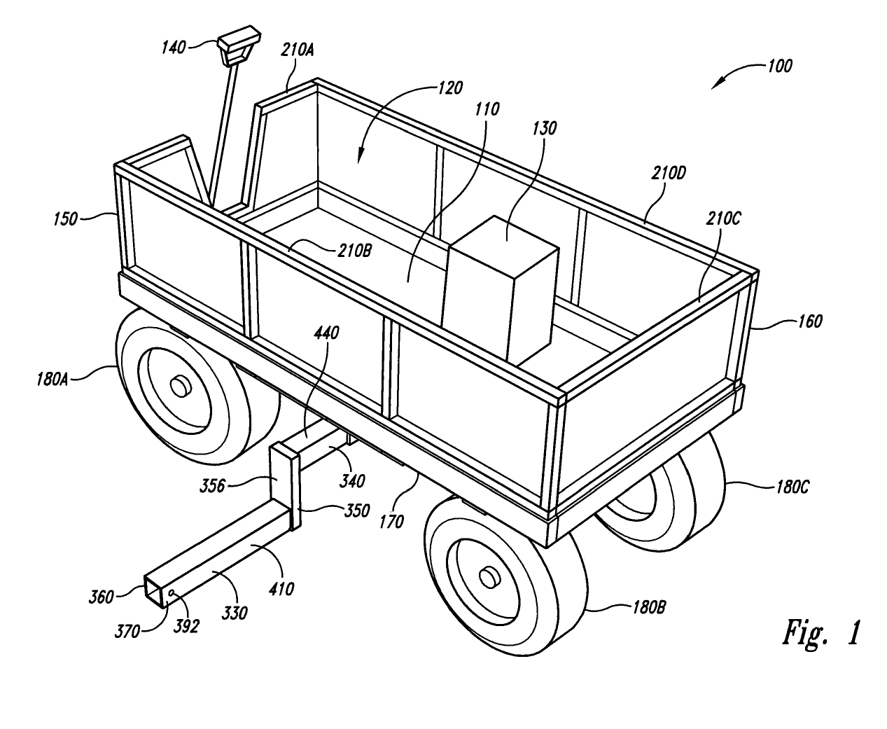

Referring to FIG. 1, aspects of the present invention relate to a cart 100. As used herein the term “cart” refers to a manually powered vehicle having any number of wheels used to transport a cargo. Carts may be pushed and/or pulled by a user. Non-limiting examples of carts include wagons, wheelbarrows, two-wheeled carts, and the like. As is appreciated by those of ordinary skill, the embodiment of the cart 100 depicted in the figures is a wagon. However, through application of ordinary skill in the art, the technology disclosed herein could be applied to any type of cart and such embodiments are within the scope of the present invention.

The cart 100 has a top side 110 including a cargo area 120 into which a cargo 130 may be loaded for transport. The illustrated cart 100 has a handle 140 by which the user may power and steer the cart 100. The cart 100 also has a front portion 150 and a back portion 160 opposite the front portion 150. Because the cart 100 depicted in the figures is a wagon, it has the single handle 140 mounted to the front portion 150 by which the user may pull the cart. However, as is appreciated by those of ordinary skill in the art, if the cart 100 is instead a wheelbarrow or other type of cart, the cart may have two handles mounted to the back portion 160 by which the user may push the cart.

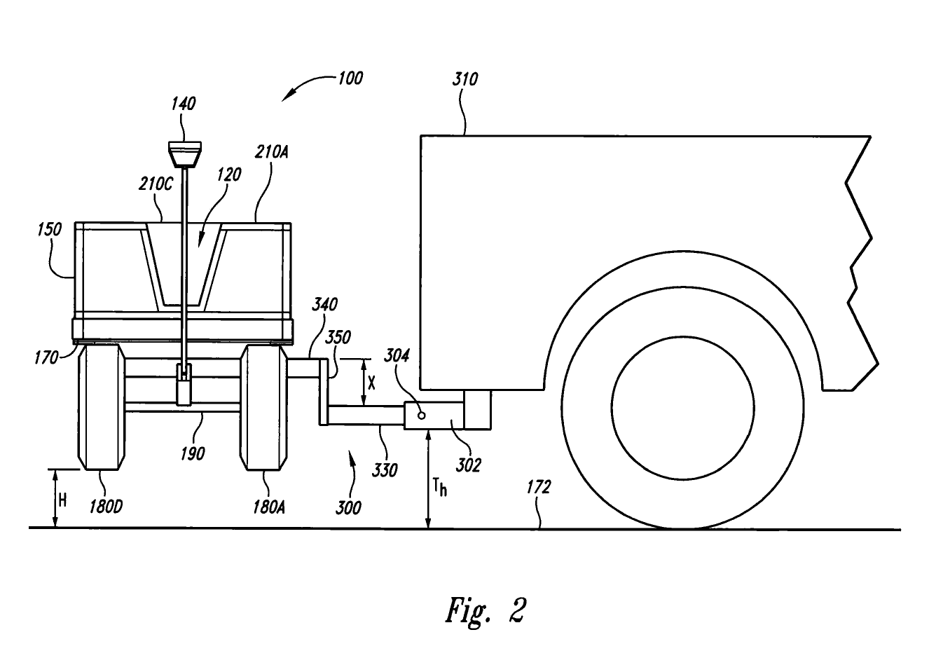

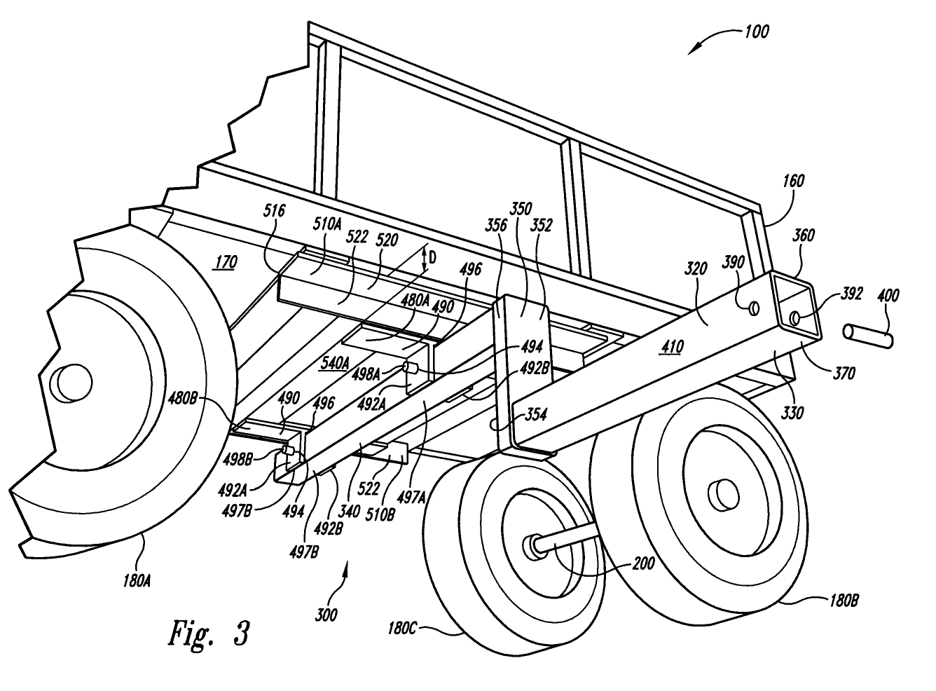

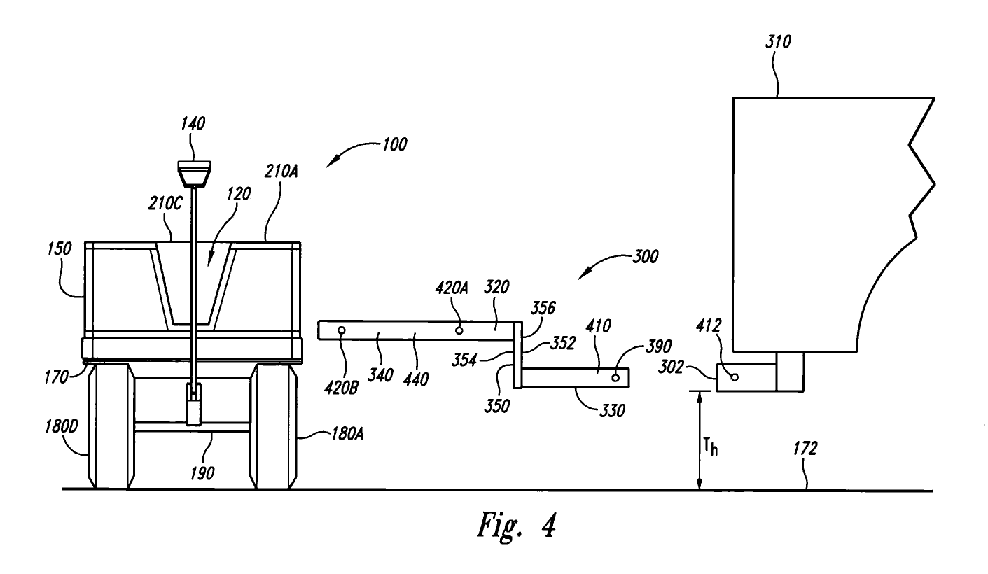

Referring to FIG. 2, the cart 100 has an underside 170 opposite the top side 110 (depicted in FIG. 1). When the cart 100 is disposed on the ground 172 (see FIG. 4), the underside 170 is supported above the ground by wheels 180A-180D and/or stationary upright support members (not shown). One pair of wheels 180A and 180D may be rotatably mounted to a front axle 190 mounted to the front portion 150 of the cart and a second pair of wheels 180B and 180C (see FIG. 3) may be rotatably mounted to a back axle 200 mounted to the back portion 160 of the cart. In accordance with wagon construction techniques well-known in the art, the handle 140 may be operably coupled to the front axle 190 and used to steer the cart 100.

As is appreciated by those of ordinary skill in the art, if the cart 100 is a wheelbarrow, the cart may have a single wheel rotatably mounted to the front portion 150 of the wheelbarrow and a pair of stationary upright support members mounted to the back portion 160 of the wheelbarrow. Alternatively, if the cart 100 is a two-wheeled cart, the cart may have a pair of wheels rotatably mounted to a common axle mounted to the front portion 150 or the back portion 160 of the cart, or at a location therebetween, and may include one or more stationary upright support members (not shown) mounted to the two-wheeled cart.

Optionally, returning to FIG. 1, the cart 100 includes side rails or sidewalls 210A-210D that define the cargo area 120. The sidewalls 210A-210D may help maintain the cargo 130 loaded into the cargo area 120 therein during transport.

Referring to FIGS. 3 and 4, a mounting assembly 300 for mounting the cart 100 to a towing hitch receiver 302 of a vehicle 310 at its rearward end portion will be described. The towing hitch receiver 302 may be positioned at a height “Tₕ” above the ground 172 and may include a pair of opposed through-holes 304. The vehicle 310 may include any vehicle to which the towing hitch receiver 302 may be coupled that is capable of transporting the cart 100 using the technology described. The towing hitch receiver 302 depicted in the figures is typically referred to as a box hitch. However, the invention is not limited to use with a box hitch and through application of ordinary skill in the art, the present teachings may be adapted for use with many towing hitches known in the art.

As best seen in FIG. 3, the mounting assembly 300 includes a support member 320. The support member 320 may be generally elongated and have a first end portion 330 opposite a second end portion 340. The first end portion 330 may be coupled to the towing hitch receiver 302 of the vehicle 310 as shown in FIG. 2 and the second end portion 340 may be coupled to the cart 100. The first end portion 330 of the support member 320 may be separately couplable to the vehicle 310 and remain coupled thereto when the cart 100 is uncoupled from the second end portion 340 of the support member 320. Further, the cart 100 may be separately couplable to the second end portion 340 of the support member 320 and may be coupled thereto even if the first end portion 330 of the support member 320 is uncoupled from the vehicle 310.

In the embodiment depicted in the figures, an upright member 350 couples the first end portion 330 to the second end portion 340. The upright member 350 has a first side 352 opposite a second side 354. The first end portion 330 is coupled to the first side 352 of the upright member 350 and the second end portion 340 is coupled to the second side 354 of the upright member 350. The first end portion 330 may be coupled to the first side 352 of the upright member 350 at a location offset vertically from the second end portion 340 by an offset amount “X” (see FIG. 2). The offset amount “X” may be about 4 inches to about 8 inches, depending on the height it is desired to hold the wheels 180A-180D of the cart 100 above the ground for the particular type vehicle 310 to which the cart is being coupled. In particular embodiments, the offset amount “X” may be about 6 inches.

The upright member 350 may be constructed in any manner known in the art. In the embodiment depicted in the figures, the upright member 350 is a solid plate section 356.

The first end portion 330 of the support member 320 is constructed from a section of square tubing 410 with a sidewall 360. The sidewall 360 is constructed of suitable thickness to support the weight of the cart 100 and the cargo 130 carried in the cargo area 120 when a distal end portion 370 of the first end portion is inserted into the towing hitch receiver 302. The distal end portion 370 of the sidewall 360 includes a first through-hole 390 and a second through-hole 392 on opposite lateral sidewall portions with the first and second through-holes in alignment so as to receive a fastener 400, such as a pin, a bolt, and the like, extending through both.

The distal end portion 370 of the first end portion 330 is shown as square but other cross-sectional shapes such as round, rectangular and the like may be used so long as compatible with the towing hitch receiver 302 or other type hitch used by the vehicle 310. The distal end portion 370 of the first end portion 330 may also be a solid square member or any other suitable shape.

The distal end portion 370 of the end portion of the first end portion 330 is configured to be received within the towing hitch receiver 302, so that when received therein the pair of through-holes 304 (see FIG. 2) of the towing hitch receiver are aligned with both the first and second through-holes 390 and 392 of the distal end portion 370. After the pair of through-holes 304 are aligned with both the first and second through-holes 390 and 392 of the distal end portion 370, the fastener 400 may be inserted fully through pair of through-holes 304 of the towing hitch receiver 302 and the first and second through-holes 390 and 392 of the distal end portion 370 to maintain the distal end portion securely inside the towing hitch receiver 302 and to prevent the distal end portion 370 of the end portion of the first end portion 330 from rotating therein when the cart 100 is coupled to the vehicle 310 with the cart's wheels 180A-180D above the ground. If the distal end portion 370 of the first end portion 330 of the support member 320 is coupled to the towing hitch receiver 302 of the vehicle 310 without the cart 100 being previously coupled to the second end portion 340 of the support member 320, the cart 100 may next be coupled to the second end portion 340 of the support member 320 for transport by the vehicle 310, as will be described below.

As may best be viewed in FIG. 4, the second end portion 340 may include a first through-hole 420A and a second through-hole 420B spaced longitudinally from the first through-hole 420A along the second end portion 340. In the embodiment depicted in the figures, the second end portion 340 is constructed from the same material used to construct the first end portion 330 (i.e., a section of square tubing 440). The sidewall 360 of the square tubing 440 is constructed of suitable thickness to support the weight of the cart 100 and the cargo 130 carried in the cargo area 120 when a distal end portion 370 of the first end portion is inserted into the towing hitch receiver 302. The second end portion 340 may also be a solid square member or any other suitable shape.

The first end portion 330 of the support member 320, the second end portion 340 of the support member 320, and the upright member 350 may be constructed from any suitable material known in the art including aluminum, steel, and the like. By way of non-limiting example, the first end portion 330 may be welded to the first side 352 of the upright member 350, and the second end portion 340 may be welded to the second side 354 of the upright member 350.

Referring to FIGS. 3 and 4, the mounting assembly 300 includes one or more brackets 480 (e.g., brackets 480A and 480B) mounted to the underside 170 of the cart 100. In the embodiment depicted in the figures, a pair of spaced apart brackets 480A and 480B are used. However, through application of ordinary skill in the art to the teachings provided herein, the embodiment depicted may be modified to include a single bracket or more than two brackets.

The brackets 480A and 480B are configured to be removably coupled to the second end portion 340 of the support member 320. The cart 100 may be lifted and the brackets 480A and 480B placed atop the second end portion 340 of the support member 320 and coupled thereto when the distal end portion 370 of the first end portion 330 of the support member 320 has previously been coupled to the towing hitch receiver 302 of the vehicle 310. When the cart 100 is coupled to the support member 320 by the brackets 480A and 480B, the support member 320 provides a cantilever support arm extending from the towing hitch 302 upon which the cart 100 may be transported. Of course, if desired, the cart 100 may be coupled to the support member 320 before the distal end portion 370 of the first end portion 330 of the support member 320 is coupled to the towing hitch receiver 302 of the vehicle 310, in which case the entire cart 100, any cargo 130 therein and the attached support member must be lifted to insert the distal end portion 370 of the first end portion 330 of the support member 320 into the towing hitch receiver 302.

Each of the brackets 480A and 480B includes a mounting plate 490 mounted to the underside 170 of the cart 100 and a pair of spaced apart confronting flanges 492A and 492B defining a channel 493 therebetween sized to receive the second end portion 340 of the support member 320 between the confronting flanges. Each of the flanges 492A and 492B includes a through-hole 494. Each of the flanges 492A and 492B extends downwardly from the mounting plate 490 and flanks a mid-portion 496 of the mounting plate 490.

When the cart 100 is elevated and the bracket 480A placed atop the second end portion 340 of the support member 320, a first portion 497A of the second end portion 340 of the support member 320 is received between the flanges 492A and 492B and into the channel 493. The mid-portion 496 of the mounting plate 490 located between the flanges 492A and 492B of the bracket 480A rests upon the first portion 497A of the second end portion 340. When the bracket 480B is placed atop the second end portion 340 of the support member 320, a second portion 497B of the second end portion 340 of the support member 320 is received between the flanges 492A and 492B and into the channel 493. The mid-portion 496 of the mounting plate 490 located between the flanges 492A and 492B of the bracket 480B rest upon the second portion 497B of the second end portion 340. The first portion 497A of the second end portion 340 of the support member 320 includes the through-hole 420A and the second portion 497B of the second end portion 340 includes the through-hole 420B.

The through-hole 494 formed in the flange 492A is aligned with the through-hole 494 formed in the flange 492B. In this manner, a single fastener 498 (e.g., a pin, a bolt, and the like) may be inserted into the through-hole 494 formed in the flange 492A and the through-hole 494 formed in the flange 492B.

When the first portion 497A of the second end portion 340 of the support member 320 is received between the flanges 492A and 492B of the bracket 480A, the through-hole 420A is aligned with both the through-hole 494 formed in the flange 492A and the through-hole 494 formed in the flange 492B. Then, the fastener 498A (e.g., a pin, a bolt, and the like) is inserted fully through the through-holes 494 and the through-hole 420A. The fastener 498A helps maintain the cart 100 upon the support member 320 during transport.

Similarly, when the second portion 497B of the second end portion 340 of the support member 320 is received between the flanges 492A and 492B of the bracket 480B, the through-hole 420B is aligned with both the through-holes 494 formed in the flange 492A and the flange 492B. Then, the fastener 498B is inserted through the through-holes 494 and the through-hole 420B. The fastener 498B helps maintain the cart 100 upon the support member 320 during transport.

Returning to FIG. 2, after the first end portion 330 is coupled to the towing hitch receiver 302 of the vehicle 310 using the fastener 400 with the cart 100 coupled to the second end portion 340 using the fasteners 498A and 498B, the cart and its cargo 130 are ready for transport by the vehicle.

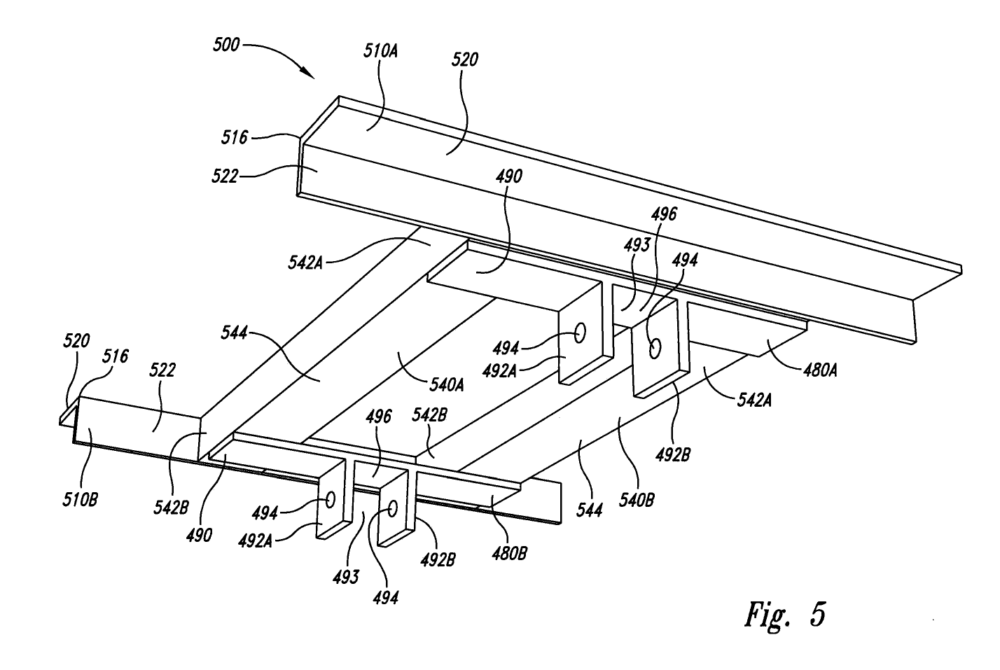

Referring to FIGS. 3 and 5, optionally, a frame assembly 500 may be used to mount the brackets 480A and 480B to the underside 170 of the cart 100. The frame assembly 500 may include two spaced apart L-shaped mounting brackets 510A and 510B. Each of the mounting brackets 510A and 510B may include a corner portion 516 flanked by a first flange portion 520 and a second flange portion 522. The first portion 520 may abut the underside 170 of the cart 100 and may be coupled thereto. The second portion 522 may extend downwardly from the underside 170 of the cart 100.

Referring to FIG. 5, the frame assembly 500 may include one or more spaced apart transverse members 540 (e.g., transverse members 540A and 540B) extending between the mounting brackets 510A and 510B. Each of the transverse members 540 may have a first end portion 542A and a second end portion 542B opposite the first end portion 542A. Each of the transverse members 540 may also have a mounting surface 544. The first end portion 542A of each of the transverse members 540 may be coupled to the second portion 522 of the mounting bracket 510A and the second end portion 542B of each of the transverse members 540 may be coupled to the second portion 522 of the mounting bracket 510B.

The mounting plates 490 of the brackets 480A and 480B may be mounted to the mounting surfaces 544 of the transverse members 540. In this manner, the brackets 480A and 480B are positioned a distance “D” below the underside 170 of the cart 100 (see FIG. 3). The distance “D” may be about one inch to about 2.5 inches. In particular embodiments, the distance “D” may be about 1.75 inches. The frame assembly 500 may help distribute the forced applied to the brackets 480A and 480B to a larger portion of the underside 170 of the cart 100 than would experience such forces if the brackets 480A and 480B were coupled directly to the underside 170 of the cart 100.

Turning to FIG. 2, as is apparent to those of ordinary skill in the art, when the cart 100 is coupled to the vehicle 310 by the mounting assembly 300, the wheels 180A-180D of the cart 100 are suspended above the ground at a height “H.” The height “H” may be determined at least in part by the offset amount “X” (see FIG. 3). Further, the height “H” may be determined at least in part by a height “Tₕ” of the towing hitch 302 above the ground. In embodiments in which the brackets 480A and 480B are mounted to the underside 170 of the cart 100 by the frame assembly 500 (see FIG. 3), the distance “D” from the underside of the cart at which the frame assembly 500 mounts the brackets 480A and 480B may help determine, at least in part, the height “H.” The diameter of the wheels 180A-180D may also may help determine, at least in part, the height “H.” Therefore, any of these parameters may be adjusted to obtain the desired height “H.”

Because it is undesirable for the wheels 180A-180D of the cart 100 to contact the ground 172 during transport and such contact may create unsafe conditions, in the embodiment depicted in the figures, the height “H” is selected to be sufficient to prevent the wheels from contacting the ground during normal transport on surface streets. However, the height “H” should not be so large as to make lifting or otherwise elevating the cart 100 unduly difficult. Therefore, determining the height “H” may involve a balancing of these two concerns.

The cart 100 may be transported empty or loaded with cargo 130. If the cart 100 is transported empty, it may be desired to position the empty cart 100 near the second end portion 340 of the support member 320 with the first end portion 330 already coupled the towing hitch receiver 302 of the vehicle 310. Then, the cart 100 is lifted to at least the height “H” and the brackets 480A and 480B are positioned upon the second end portion 340 of the support member 320. The first portion 497A of the second end portion 340 of the support member 320 is received between the flanges 492A and 492B of the bracket 480A, and rested upon the portion 496 of the mounting plate 490 between the flanges. The second portion 497B of the second end portion 340 of the support member 320 is received between the flanges 492A and 492B of the bracket 480B, and rested upon the portion 496 of the mounting plate 490 located between the flanges. The through-holes 420A and 420B are aligned with the through-holes 494 formed in the flanges 492A and 492B of the brackets 480A and 480B, respectively. The cart 100 (and thus the brackets 480A and 480B) may be slid along the second end portion 340 until this alignment is achieved. Alternatively, the cart 100 may be lifted and repositioned. Then, the fasteners 498A and 498B are then installed in the brackets 480A and 480B, respectively.

If the cart 100 is to be transported loaded with cargo 130, the cargo may be loaded into the cargo area 120 of the cart 100 before the cart is lifted or otherwise elevated to at least the height “H.” Alternatively, before the cart 100 is loaded it may be lifted and coupled to the second end portion 340. Then, the cargo 130 may be placed into the cargo area 120 of the cart 100 for transport.

After the cart 100 is coupled to the support member 320, which is coupled to the towing hitch receiver 302 of the vehicle 310, the vehicle may be driven to a selected location where the cart is needed.

At the selected location, the fasteners 498A and 498B may be unfastened and the cart 100 lowered to the ground for use. Optionally, the support member 320 may be uncoupled from the towing hitch receiver 302 by removing the fastener 400 and disengaging the first end portion 330 from the towing hitch receiver. If the cart 100 was transported loaded, the cargo 130 may be unloaded before the cart is lowered to the ground. Alternatively, the cart 100 may be lowered to the ground while the cargo 130 is inside the cargo area 120.

The cart 100 and the vehicle 310 are each configured to have a forward direction of travel during use. In the embodiment depicted in the figures, the mounting assembly 300 positions the cart 100 so that during transport, the forward direction of travel the cart would have if it were not suspended above the ground is substantially orthogonal to the forward direction of travel of the vehicle 310. In other words, the cart 100 is positioned transverse to the longitudinal length of the vehicle 310. However, this is not a requirement and the mounting assembly 300 may be modified through application of ordinary skill to orient the cart 100 differently with respect to the vehicle 310. For example, instead of mounting the brackets 480A and 480B between the front portion 150 and back portion 160 of the cart 100, the brackets may be mounted to the front portion 150 between the front wheels 180A and 180D (or to the back portion 160 between the back wheels 180B and 180C).

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A cart for removably coupling to a rearward end portion of a vehicle, the cart comprising:
a support member couplable to the rearward end portion of the vehicle;
a front portion having at least one ground-engaging support member;
a back portion opposite the front portion having at least one ground-engaging support member;
an underside supported above the ground by the at least one ground-engaging support member of the front portion and the at least one ground-engaging support member of the back portion; and
at least one mounting bracket mounted to the underside of the cart between the at least one ground-engaging support member of the front portion and the at least one ground-engaging support member of the back portion, the at least one mounting bracket being removably couplable to the support member when the support member is coupled to the rearward end portion of the vehicle.

2. The cart of claim 1, further comprising:
a support frame mounted to the underside of the cart and configured to mount the at least one mounting bracket to the underside of the cart.

3. The cart of claim 1, wherein the at least one mounting bracket comprises a pair of mounting brackets, each mounting bracket of the pair being configured to receive and removably couple to a portion of the support member, the pair of mounting brackets being spaced apart from each another along the support member.

4. The cart of claim 1, wherein the at least one mounting bracket comprises a pair of spaced apart confronting mounting flanges, each flange of the pair of flanges comprising a through-hole, the through-holes of the pair of flanges being arranged to receive a fastener,
a portion of the support member is received between the pair of flanges of the at least one mounting bracket, the portion of the support member comprising a through-hole configured to receive the fastener,
the through-hole formed in the portion of the support member is aligned with the through-holes in the pair of flanges,
the fastener is received by the through-holes of the pair of flanges of the at least one mounting bracket and the through-hole formed in the portion of the support member when the portion of the support member is received between the pair of flanges, and
the fastener is configured to maintain the portion of the support member between the pair of flanges.

5. The cart of claim 1, wherein the support member is couplable to a towing hitch coupled to the rearward end portion of the vehicle.

6. The cart of claim 5, wherein the towing hitch comprises a box hitch.

7. A cart for being removably coupled to a vehicle for transport by the vehicle, the cart comprising:
a front portion having at least one ground-engaging support member;
a back portion opposite the front portion having at least one ground-engaging support member;
a body portion supported above the ground by the at least one ground-engaging support member of the front portion and the at least one ground-engaging support member of the back portion when the ground-engaging support members are in engagement with the ground; and
a support member having a first end portion removably couplable to the vehicle and a second end portion coupled to the body portion, the support member being shaped to hold the ground-engaging support members above the ground during transport by the vehicle when the first end portion is coupled to the vehicle.

8. The cart of claim 7 further including an underside and at least one mounting bracket mounted to the underside between the at least one ground-engaging support member of the front portion and the at least one ground-engaging support member of the back portion, the at least one mounting bracket being removably couplable to the second end portion of the support member.

9. A mounting assembly for mounting a cart by its underside to a towing hitch mounted to a vehicle, the mounting assembly comprising:
a support member having a first end portion and a second end portion, the first end portion being configured to be coupled to the towing hitch mounted to the vehicle and the second end portion being configured to be removably coupled to the underside of the cart; and
at least one mounting bracket mounted to the underside of the cart and extending downwardly therefrom, the at least one mounting bracket being configured to receive and removably couple to a portion of the second end portion of the support member.

10. The mounting assembly of claim 9, wherein the vehicle has a longitudinal axis,
the second end portion of the support member extends away from the vehicle along a direction substantially parallel to the longitudinal axis of the vehicle,
the cart has a longitudinal axis, and
the cart is positioned so that its longitudinal axis is substantially orthogonal to the longitudinal axis of travel of the vehicle when the at least one mounting bracket mounted to the underside of the cart is removably coupled to the portion of the second end portion of the support member.

11. The mounting assembly of claim 9, further comprising:
a support frame mounted to the underside of the cart and configured to mount the at least one mounting bracket to the underside of the cart.

12. The mounting assembly of claim 9, wherein the at least one mounting bracket comprises a pair of mounting brackets, each mounting bracket of the pair being configured to receive and removably couple to a portion of the second end portion of the support member, the pair of mounting brackets being spaced apart from each another along the second end portion of the support member.

13. The mounting assembly of claim 9, wherein the at least one mounting bracket comprises a pair of spaced apart confronting mounting flanges, each flange of the pair of flanges comprising a through-hole, the through-holes of the pair of flanges being arranged to removably receive a fastener,
the portion of the second end portion of the support member received by the at least one mounting bracket comprises a through-hole configured to removably receive the fastener,
the portion of the second end portion of the support member is received between the pair of flanges and the through-hole formed in the portion of the second end portion is aligned with the through-holes in the pair of flanges, and
the mounting assembly further comprises the fastener extending through the through-hole of each of the flanges of the pair of flanges and the through-hole in the portion of the second end portion of the support member, the fastener being configured to maintain the portion of the second end portion of the support member between the pair of flanges.

14. The mounting assembly of claim 9, wherein the second end portion of the support member is offset vertically from the first end portion of the support member to position the underside of the cart above the towing hitch of the vehicle.

15. The mounting assembly of claim 9, wherein the towing hitch comprises a box hitch having a distal end portion having through-hole formed therein,
the through-hole formed in the box hitch is configured to removably receive a fastener,
the first end portion configured to be received within the box hitch,
the first end portion having a through-hole configured to removably receive the fastener,
the through-hole of the box hitch being aligned with the through-hole of the first end portion when the first end portion is received within the box hitch, and
the mounting assembly further comprises the fastener received within the through-holes of the first end portion and the box hitch, the fastener removably coupling the first end portion of the support member to the towing hitch of the vehicle.

16. A method of transporting a cart having an underside from a first location to a second location with a vehicle having a towing hitch, the method comprising:
at the first location:
coupling an elongated support member to the towing hitch, the elongated support member being configured to support the cart by its underside at a predetermined height above the ground;
mounting a pair of spaced apart brackets to an underside of the cart, the pair of brackets being positioned to be coupled to the elongated support member;
elevating the cart to the predetermined height above the ground;
coupling the pair of brackets mounted to the underside of the cart to the elongated support member;
moving the vehicle from the first location to the second location;
at the second location:
uncoupling the pair of brackets mounted to the underside of the cart from the elongated support member; and
lowering the cart from the predetermined height above the ground to the ground.

17. The method of claim 16, wherein the towing hitch comprises a box hitch, the elongated support member comprises a distal end portion sized to be received within the box hitch and couple the elongated support member to the box hitch comprises:
inserting the distal end portion of the elongated support member into the box hitch, and
fastening the distal end portion of the elongated support member to the box hitch.

18. The method of claim 16, wherein each of the brackets of the pair of brackets comprises a channel configured to receive a portion of the elongated support member and coupling the pair of brackets mounted to the underside of the cart to the elongated support member comprises:
placing each of the portions of the elongated support member into the respective channel of the bracket configured to receive the portion of the elongated support member; and
fastening each of the portions of the elongated support member into the respective channel of the bracket configured to receive the portion of the elongated support member.

19. The method of claim 16, further comprising:
at the first location, placing an item in the cart; and
maintaining the item in the cart when the vehicle is moved from the first location to the second location.

20. A kit for making a cart transportable on a towing hitch of a vehicle, the kit comprising:
a support member couplable to the towing hitch of the vehicle;
a frame mountable to an underside of the cart, the frame comprising at least one bracket configured to removably couple to the support member; and
at least one fastener configured to removably fasten the at least one bracket to the support member.

21. The kit of claim 20, further comprising a fastener configured to couple the support member to the towing hitch of the vehicle by fastening the support member to the towing hitch of the vehicle.
